(19) United States
(12) Patent Application Publication
(10) Pub. No.: US 2013/0140223 A1
(43) Pub. Date: Jun. 6, 2013

(54) Liquid Filter and Filter Element With an Additive Container

(71) Applicant: MANN+HUMMEL GMBH, Ludwigsburg (DE)

(72) Inventors: Pamela Gohl, Remseck (DE); Uwe Hartmann, Steinheim (DE); Michael Harenbrock, Ludwigsburg (DE); Jobst Eisengraeber-Pabst, Benningen (DE); Joerg Menssen, Tamm (DE); Pius Trautmann, Stuttgart (DE); Martin Weindorf, Kornwestheim (DE)

(73) Assignee: MANN+HUMMEL GMBH, Ludwigsburg (DE)

(21) Appl. No.: 13/692,284

(22) Filed: Dec. 3, 2012

(30) Foreign Application Priority Data
Dec. 2, 2011 (DE) 102011119986.5

(51) Int. Cl. B01D 35/00

(52) U.S. Cl. CPC B01D 35/005
USPC 210/198.1

(57) ABSTRACT

A filter housing (12) includes a first passage (20) allowing liquid to enter and a second passage (22) allowing liquid to exit. A filter element (26) separates the at least first passage (20) from the at least second passage (22) and is disposed in the filter housing (12). A filter medium (28) encloses the circumference of an element interior space (30) and has at an end face an element passage (38) which is connected with the passage (22). The filter medium (28) is surrounded by an element exterior space (42) which is connected with the other passage (20). An additive container (48) is disposed in the element interior space (30) and includes at least one flow through opening (56, 58) connecting a container interior space (68) with at least one section (64) of the element interior space (30) outside of the additive container (48).

### CROSS REFERENCE TO RELATED APPLICATIONS

This application claims the benefit under 35 USC 119 of foreign application DE 10 2011 119 986.5 filed in Germany on Dec. 2, 2011, and which is hereby incorporated by reference in its entirety.

### TECHNICAL FIELD

The invention relates to a liquid filter, in particular for oil, fuel or water, in particular of an internal combustion engine, in particular of a motor vehicle, with a filter housing that features at least a first passage for the inlet of liquid and at least a second passage for the outlet of the liquid and in which a filter element is disposed, that separates the at least first passage from the at least second passage and that features a filter medium which surrounds closely the circumference of an element interior space of the filter element relative to an imagined filter element axis which is connected with the at least one passage, and which is surrounded by an element exterior space that is connected with the other at least one passage, and that can be flowed through for filtering liquid relative to the filter element axis radially outside, from the element exterior space towards radially inside to the element interior space, or reversely, and with an additive container for the liquid which is disposed in the element interior space and which features at least one flow through opening for liquid which connects a container interior space of the additive container with at least one area of the element interior space outside of the additive container.

Furthermore, the invention relates to a filter element of a liquid filter, in particular for oil, fuel or water, in particular of an internal combustion engine, in particular of a motor vehicle that can be disposed in a filter housing that features at least a first passage for the inlet of the liquid and at least a second passage for the outlet of the liquid, in such a way that it separates the at least first passage from the at least second passage and that features a filter medium which surrounds closely the circumference of an element interior space of the filter element relative to an imagined filter element axis which can be connected with the at least one passage, and that can be flowed through for filtering liquid relative to the filter element axis radially outside towards radially inside to the element interior space, or reversely, and that features an additive container for an additive for the liquid which is disposed in the element interior space and which features at least one flow through opening for liquid which connects a container interior space of the additive container with at least one area of the element interior space outside of the additive container.

### BACKGROUND OF THE INVENTION

An oil treatment filter for being used in an internal combustion engine is known from U.S. Pat. No. 7,018,531 B2. The oil treatment filter features a mechanical filter element and a central additive container for a gradual discharge of an oil additive. The additive container contains an oil treatment material. The additive can be provided as massive block in a storage chamber of the additive container. The additive can also be provided in the form of tablets. The central arrangement of the additive container allows a filtration of the liquid through the mechanical filter element before the additive is added. This reduces the probability of additive being filtered too early after its initial addition. The additive container has an opening which allows a fluid connection between a storage chamber in the additive container and the exterior side of the additive container.

### SUMMARY OF THE INVENTION

An object of the present invention is to realize a liquid filter and a filter element of a liquid filter of the above-mentioned type in which the additive container mechanically supports and stabilizes the filter element, in particular the filter medium, additionally.

The object is solved according to the invention by the fact that at a radially outer circumferential side of the additive container relative to the filter element axis is disposed at least one spacer which, on the one hand, is supported by the radially outer circumferential side of the additive container and, on the other hand, is supported directly or indirectly with its side facing away from the radially outer circumferential side of the additive container at the radially internal circumferential side of the filter medium facing the element interior space relative to the filter element axis.

According to the invention, the filter medium is thus supported by the at least one spacer against the circumferential side of the additive container. In this way, the additive container stabilizes the filter medium additionally. Furthermore, the additive container is positioned through the at least one spacer in the element interior space. The manufacture and assembly of the filter element can be simplified by the at least one spacer. The radially outer circumferential side of the additive container is kept at a distance to the radially inner circumferential side of the filter medium by the at least one spacer. In this way, a flow chamber for the liquid is realized between the additive container and the filter medium. This flow chamber is connected fluidically via the flow through opening with the container interior space of the additive container and with the radially inner circumferential side which, depending on the flow direction of the liquid through the filter medium, designates either the raw side or the clean side of the filter medium. The at least one spacer can be supported directly at the radially inner circumferential side of the filter medium so that the additive container itself can ensure the function of a support tube and that a separate support tube is not required. When using a support tube for supporting the filter medium, the at least one spacer can also be supported indirectly via the support tube on the inner circumferential side of the filter medium. The filter medium can advantageously be closed circumferentially in a zigzag-folded manner. Thanks to the zigzag folds, a relatively large and active filtration surface can be obtained in comparison with the outside dimensions of the filter element, The at least first passage can be at least an inlet for the liquid to be filtered and to be treated with the additive. The at least second passage can be at least an outlet for the filtered and with additive treated liquid. The imaginary filter element axis can coincide with a corresponding symmetry axis, a central axis and/or a gravity axis of the filter element, the filter housing and/or the filter medium. It can additionally or alternatively coincide with an axis of the filter housing, in particular a screw-in axis of a screwed connection between the filter housing and the filter head. Advantageously, the filter medium can clamp with its inner circumferential side a cylinder jacket or an envelope of cone, the height axis of which can define the imaginary filter element axis. As an additive container in the meaning of the invention a kind of tank is preferably understood, the wall areas of which and the bottom area are closed to a great extent. Openings in the wall areas and the bottom area are so small that the additive contained in the additive container cannot pass through them to the exterior. The additive container is therefore also suited, in particular in contrast to a grid-like or frame-like additive carrier, to accept gel-like or granular additives.

In an advantageous embodiment, the at least one spacer can feature at least one sup-porting rib that can extend with respect to the filter element axis at least circumferentially along at least one part of the radially outer circumferential side of the additive container. The at least one supporting rib can simply be disposed on the exterior side of the additive container, in particular it can be integrally molded, glued or welded. It can be connected as one piece with the peripheral wall of the additive container. The circumferential extension of the supporting rib makes it possible that the supporting forces, which have an effect between the peripheral wall of the additive container and the inner circumferential side of the filter medium, can have an even impact along the peripheral wall of the additive container. Furthermore, the positioning of the additive container can thus be simplified in the element interior space. Furthermore, the support function acting on the filter medium can be enhanced In this way. Advantageously, the at least one supporting rib can extend in addition also to the circumferential extension in axial direction with respect to the filter element axis. In this way, the active surface of the peripheral wall of the additive container serving as support can be enlarged. Advantageously, the at least one supporting rib can also extend substantially in circumferential direction.

Advantageously, the at least one supporting rib can extend along an imaginary helical line on the radially outer circumferential side of the additive container. In this way, the surface of the peripheral wall of the additive container, which serves as support, can be enlarged easily. An even support can be realized between the additive container and the filter medium. A supporting rib extending along the helical line can be realized easily. The screw-shaped arrangement of the at least one supporting rib can further-more enhance a flow of the liquid in the flow chamber between the circumferential side of the additive container and the inner circumferential side of the filter medium. Thus, the filter function and the treatment with the additive can be enhanced. Advantageously, several screw-shaped supporting ribs can run parallel to each other. Two adjacent supporting ribs each can define a screw-shaped flow chamber.

In another advantageous embodiment, the at least one spacer can feature at least one supporting rib that can extend in parallel or diagonally with respect to the filter element axis. Straight supporting ribs can be realized easily. Supporting ribs running parallel to the filter element axis can simplify the installation of the additive container in the element interior space.

Advantageously, the at least one supporting rib can feature at least one discontinuity. A gap between two supporting ribs in alignment to each other can also be considered as discontinuity. Conversely, two supporting ribs in alignment to each other in their extension direction can be considered as one supporting rib with one discontinuity. The liquid can flow through the at least one discontinuity so that a distribution and a flow of the liquid in the flow chamber between the additive container and the filter medium can be enhanced. Thus, an even liquid distribution along the circumferential side of the additive container can be realized. Thus, an even contact with the additive and an even treatment of the liquid with additive can be made possible via the at least one flow through opening.

In another advantageous embodiment, the radially outer circumferential side of the additive container can be cylindrical or conical, and coaxial with respect to the filter element axis. Advantageously, the radially inner circumferential side of the filter medium can be accordingly cylindrical or conical. A cylindrical or conical additive container can be adapted optimally to a cylindrical or conical shape of the element interior space. In this way, a radial extension of the flow chamber between the additive container and the inner circumferential side of the filter medium can be uniform in axial direction and in circumferential direction. Thus, the fluid flow can be enhanced in this flow chamber. This can have a positive impact on the pressure ratio between a clean side and a raw side of the filter medium. The filtration effect can thus be enhanced. Furthermore, the service life of the filter element and of the liquid filter, respectively, can be extended.

Advantageously, the filter medium can be zigzag-folded circumferentially and the at least one spacer can extend circumferentially over at least two, preferably three, fold edges that form the radially inner circumferential side of the filter medium. The circumferential extension of the spacer over at least two, preferably three, fold edges can pre-vent the at least one spacer in embodiments of the filter element, in which the at least one spacer is adjacent directly to the inner circumferential side of the filter medium, which means the fold edges there, from being inserted between two adjacent fold edges. Thus, it can be avoided that a spacer inserted between two adjacent fold edges pushes apart the adjacent fold edges, which could impair the filtration effect of the filter medium. A uniform support on the radially inner fold edges of the filter medium can be realized.

In another advantageous embodiment, the at least one spacer can be supported at a radially inner circumferential side of a support tube of the filter element which can be disposed in the element interior space and on the radially outer circumferential side of which the radially inner circumferential side of the filter element can be supported indirectly or directly. The support tube can support the filter medium to stabilize its shape. The filter element with the filter medium and the support tube can also be prefabricated and the additive container can be installed easily in the element interior space during a later assembly step. The additive container can be supported by the at least one spacer in a stable manner on the inner circumferential side of the support tube, which means indirectly on the inner circumferential side of the filter medium. Thus, the additive container can be positioned easily in the interior area of the support tube. Advantageously, the additive container can be disposed coaxially in relation to the support tube. Thus, the additive container can be easily inserted into the element interior space without the need of additional positioning elements.

In another advantageous embodiment, the additive container can be connected, in particular glued or welded, at least on one front face with an end body, in particular an end plate, of the filter element which in turn is connected, in particular glued or welded, with a front face of the filter medium. In this way, the stability of the connection between the additive container and the filter medium can be further enhanced. This can have a positive effect on the stability of the entire filter element. A glued connection or a welded connection can be realized easily. A glued connection or a welded connection can furthermore also realize a sealing function. The end body, in particular the end plate, can stabilize the filter medium additionally on its front face. Furthermore, the end body can tightly seal the filter medium at its front face so that no liquid can enter or leave the element interior space.

The technical object is further solved by the filter element according to the invention by the fact that at a radially outer circumferential side of the additive container relative to the filter element axis is disposed at least one spacer which, on the one hand, is sup-ported by the radially outer circumferential side of the additive container and, on the other hand, directly or indirectly with its side facing away from the radially outer circumferential side of the additive container at the radially internal circumferential side of the filter medium facing the element interior space relative to the filter element axis. The advantages and features shown above in conjunction with the liquid filter according to the invention are valid for the filter element according to the invention and its advantageous embodiments.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 schematically depicts a half section of a spin-on filter for engine oil of an internal combustion engine of a motor vehicle with a filter element in the element interior space of which is disposed an additive container according to a first example of an embodiment which is supported with screw-shaped supporting ribs on an inner circumferential side of a support tube of the filter element;

FIG. 2 schematically depicts an isometric representation of the additive container of the spin-on filter from FIG. 1; and

FIG. 3 schematically depicts an isometric representation of an additive container according to a second example of an embodiment which is similar to the additive container in FIGS. 1 and 2 and which can be used with the spin-on filter in FIG. 1.

Identical components in the figures have the same reference numerals. Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to a liquid filter and a filter element with an additive container. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

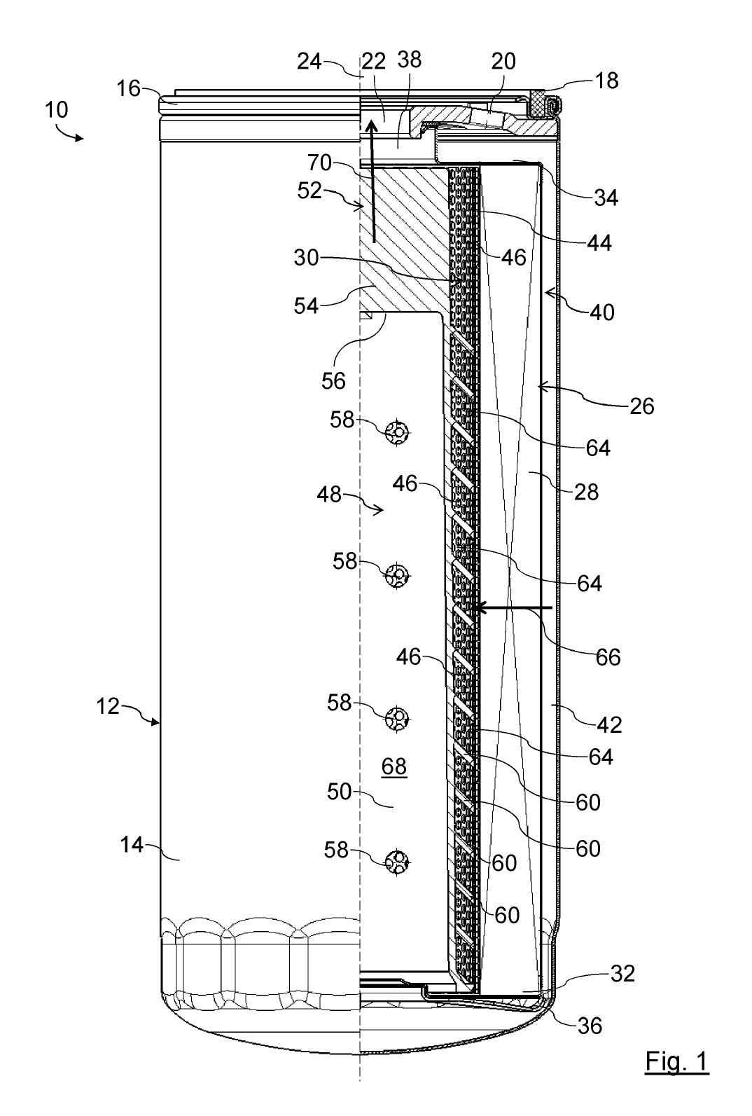

FIG. 1 shows a spin-on filter 10 for engine oil in a lengthwise half section. The spin-on filter 10 is screwed to a filter head of a filtering device, not shown in figure 1, of an engine oil line of an internal combustion engine of a motor vehicle which is of no interest here.

The spin-on filter 10 has a filter housing 12 with a pot 14 and a cover 16. In at least some embodiments, such as the illustrated exemplary embodiment of FIG. 1, the pot 14 is permanently and securely fixed to the cover 16 via a liquid-tight flare coupling such that the filter element 26 and filter housing 12 are one-piece unitary and replaced as a unit. A sealing 18 is disposed in a bead in the area of the flare coupling.

Several inlet ports 20 through which the engine oil to be cleaned can flow into the spin-on filter 10 are disposed in the cover 16. Furthermore, the cover 16 has a centrally disposed cover outlet 22 which features an internal thread for attaching the spin-on filter 10 on an outer thread of a cylindrical connecting branch of the filter head. The cover outlet 22 and the connecting branch are coaxial in relation to an imaginary axis 24 of the spin-on filter 10. In the shown example of an embodiment, the axis 24 coincides with a screw-in axis of the spin-on filter 10 around which the filter housing 12 is screwed on the connecting branch of the filter head. If, in the following, it is referred to “axial”, “radial” or “circumferentially”, this refers to the axis 24, unless otherwise mentioned.

A filter element 26 is disposed in the inside of the housing 12. The filter element 26 separates the inlet ports 20 tightly from the cover outlet 22. For this purpose, the filter element 26 has a filter medium 28 which is closed circumferentially in a zigzag-folded and star-shaped manner. The filter medium 28 defines a radially inner element interior space 30 of the filter element 26 on a clean side of the filter element 26. The radially inner circumferential side of the filter medium 28, and therefore the element interior space 30, are substantially cylindrical. In the example of an embodiment shown in FIG. 1 a filter medium axis of the filter medium 28 and an axis of the filter element 26 coincide with the axis 24.

A bottom end plate 32 and a connection end plate 34 are attached at the front faces of the filter medium 28. The bottom end plate 32 and the connection end plate 34 are preferably made of synthetic material. The bottom end plate 32 closes the element interior space 30 on the front face of the filter element 26 facing the bottom of the pot 14, in FIG. 1 below. Support members 36 support the bottom end plate 32 against the bottom of the pot 14.

The connection end plate 34 is substantially designed as annular plate, the inner section of which in the shape of a connecting piece is bent away from the element interior space 30. A central opening of the connection end plate 34 forms a coaxial element outlet 38 in relation to the cover outlet 22, through which leads the connecting branch of the filter head when the spin-on filter 10 is mounted. The element outlet 38 is tightly connected with the connecting branch. In this way, the clean-sided element interior space 30 of the filter element 26 is separated from a raw side 40 of the filter medium 28. An annular space 42 that surrounds the filter medium 28 radially outside is disposed at the raw side 40.

A support tube 44 that is coaxial in relation to the axis 24 extends between the bottom end plate 32 and the connection end plate 34 in the element interior space 30. The support tube 44 is preferably made of synthetic material. The support tube 44 is firmly connected, preferably glued or welded, with the bottom end plate 32 and with the connection end plate 34 as well. The radially inner circumferential side of the filter medium 28 is placed directly on the radially outer circumferential side of the support tube 44. The support tube 44 has in its peripheral wall a plurality of inlet apertures 46 for the filtered engine oil. The internal diameter of the support tube 44 is larger than the outer diameter of the element outlet 38.

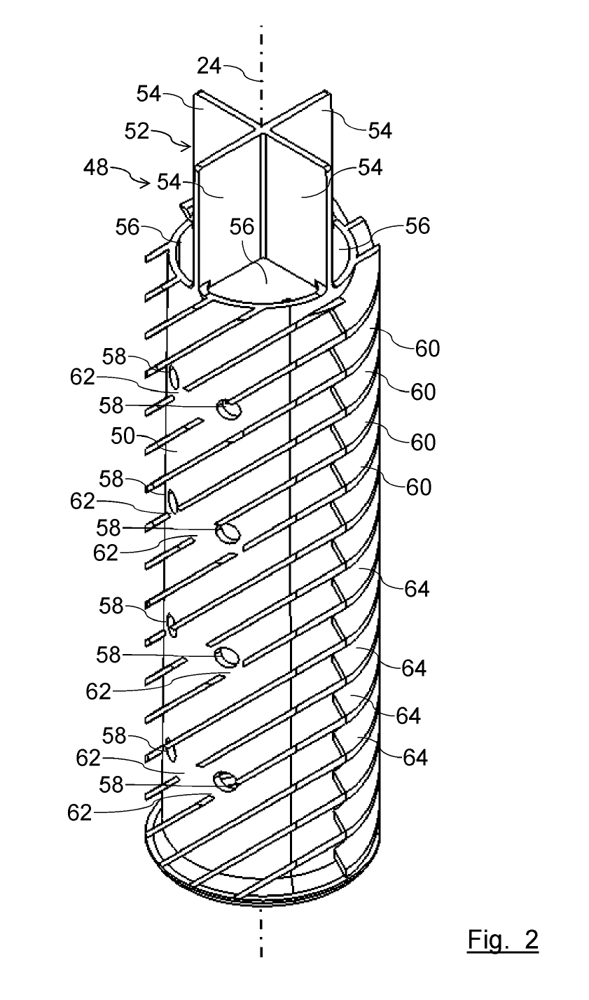

An additive container 48 shown in detail in FIG. 2 is furthermore disposed in the element interior space 30. The additive container 48 contains an additive for treating the engine oil. The additive is not shown in FIG. 1 to ensure a better clarity. The additive can preferably be available as gel. However, it can also be available as granulate or in tablet form. When the spin-on filter 10 is in operation, the additive is gradually delivered to the engine oil that flows through the spin-on filter 10.

The additive container 48 features a lower cylinder-shaped storage section 50 which is disposed coaxially in relation to the axis 24. With a lower front face shown in FIG. 1, the storage section 50 that is open there is supported tightly on the bottom end plate 32. The storage section 50 forms in conjunction with the bottom end plate 32 a tank that is substantially closed towards the bottom and circumferentially. This tank is also able to receive a fluid or granular additive. At the side facing the connection end plate 34, the storage section 50 merges into a one-piece cross bracing 52. At the side facing the connection end plate 34, the cross bracing 52 is supported at the interior side of the connection end plate 34 facing the element interior space 30 in axial direction. Thus, the additive container 48 is completely fixed between the connection end plate 34 and the bottom end plate 32 in axial direction. The cross bracing 52 consists of four crosswise arranged plates 54 that extend each radially and axially in relation to the axis 24. The plates 54 meet in the axis 24 and are connected there with each other to form one piece.

The storage section 50 features at its front face facing the cross bracing 52 an opening that is divided by the plates 54 into four similar opening segments 56. The opening segments 56 are among others shown in FIG. 2. In the circumferential side of the storage section 50, a plurality of inlet apertures 58 for engine oil is disposed in circumferential direction and in axial direction. The diameters of the inlet apertures 58 are small compared with the total area of the circumferential side of the storage section 50. They are dimensioned in such a way that the additive cannot flow through them from the additive container 48 into the element interior space 30 surrounding the container. The diameters of the inlet apertures 58 and/or their total area can be predefined for setting a discharge quantity of additive per flow rate of engine oil.

A plurality of supporting ribs 60 is disposed at the radially outer circumferential side of the storage section 50. The supporting ribs 60 are connected each as one piece with a peripheral wall of the storage section 50. The supporting ribs 60 are bent diagonally downwards towards the bottom end plate 32. The supporting ribs 60 extend each in a screw-shaped manner around the axis 24. The supporting ribs 60 run parallel to each other. They extend in axial direction over the complete storage section 50. The supporting ribs 60 extend each in radial direction up to the radially inner circumferential side of the support tube 44. The supporting ribs 60 are supported indirectly by the side facing away from the outer circumferential side of the storage section 50 of the additive container 48 via the support tube 44 at the radially inner circumferential side of the filter medium 28. In this way, the additive container 48 supports the filter medium 28 via the supporting ribs 60 and the support tube 44 and stabilizes the filter element 26. Furthermore, the supporting ribs 60 position the additive container 48 in the element interior space 30.

Each supporting rib 60 features a plurality of discontinuities 62. The discontinuities 62 are disposed each in the area of one of the inlet apertures 58. Due to the discontinuities 62, screw-shaped flow chambers 64, which extend each between two adjacent supporting ribs 60, are connected with each other.

The areas of each of the supporting ribs 60 between two discontinuities 62 extend each circumferentially over at least two, preferably at least three, radially inner fold edges of the zigzag-folded filter medium 28. In this way, the additive container 48 is uniformly supported in relation to the support tube 44 and the filter medium 28.

When the spin-on filter 10 is operating, engine oil is delivered from the engine-oil circuit through the inlet ports 20 to the annular space 42. The engine oil flows through the filter medium 28 from the annular space 42, radially outside, to the element interior space 30, radially inside, shown in FIG. 1 by an arrow 66. The filtered engine oil flows through the support tube 44 through the inlet aperture 46 and reaches the flow chambers 64 between the storage section 50 of the additive container 48 and the support tube 44. From there, one part of the filtered engine oil reaches through the inlet apertures 58 a container interior space 68 of the additive container 58. In the container interior space 68, the engine oil comes into contact with the additive therein which is gradually delivered to the engine oil. The engine oil that is filtered and treated with additive passes the cross bracing 52 that homogenizes the flow. The engine oil flows through the element outlet 38 and the cover outlet 24, shown in FIG. 1 by an arrow 70, from the spin-on filter 10 into the connecting branch of the filter head and from there back to the engine-oil circuit.

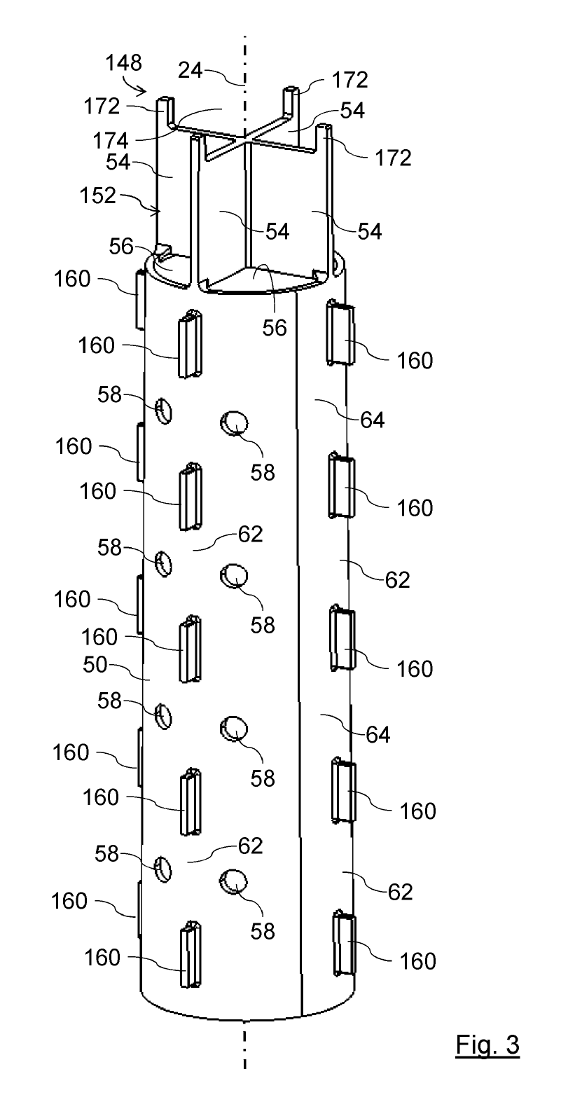

In FIG. 3 is shown a second example of an embodiment of an additive container 148 which is similar to the additive container 48 from the first example of an embodiment in FIGS. 1 and 2. Those elements that are similar to those in the first example of an embodiment have the same reference numerals. The second example of an embodiment is different from the first example of an embodiment by the fact that instead of the screw-shaped supporting ribs 60 a plurality of supporting ribs 160 is provided that extend each in axial direction. The supporting ribs 160 are disposed in four each axially extending groups with five supporting ribs 160 each. The supporting ribs 160 of an axial group are aligned in axial direction. Between the adjacent supporting ribs 160 of an axial group there is one discontinuity 62 each. In other words, each axial group of supporting ribs 160 represents one axial supporting rib that is divided by the four discontinuities 64 into four supporting rib parts 160. The four supporting rib groups are evenly distributed at the radially outer circumferential side of the storage section 50.

Furthermore, the cross bracing 152 in the second example of an embodiment has four supporting lugs 172 which are disposed each radially outside at the free sides of the plates 54 facing away from the storage section 50 and extend in axial direction away from the storage section 50. When the spin-on filter 10 is assembled, the supporting lugs 172 are supported at the connection end plate 34 of the filter element 26. The sup-porting lugs 172 act as further spacers via which a flow chamber 174 is realized which connects the four volume sections between the plates 54.

In all above described examples of an embodiment of a spin-on filter 10 and a filter element 26, the following modifications are among others possible:

The invention is not limited to spin-on filters 10 for engine oil of internal combustion engines. Rather, it can also be used with different liquid filters, for example for fuel or water. The invention can also be used outside the automotive technology, for example with industrial engines.

Instead of the spin-on filter 10, it is also possible to use a filter with an openable filter housing in which the filter element 26 can be disposed replaceably.

Instead of being disposed in the area of the inlet apertures 58, the discontinuities 62 of the supporting ribs 60 can also be disposed in distant areas of the peripheral wall of the storage section 50.

At least in the first example of an embodiment in FIGS. 1 and 2 the support tube 44 is not required. In this case, the supporting ribs 60 can be supported directly at the inner circumferential side of the filter medium 28, which means the radially inner fold edges there.

In the first example of an embodiment, only one screw-shaped extending supporting rib can be provided instead of the plurality of screw-shaped extending supporting ribs 60.

In the second example of an embodiment, the supporting ribs 160 can also extend diagonally in relation to the axis 24 instead of extending in axial direction.

Instead of the screw-shaped supporting ribs 60 and the axial supporting ribs 160, circumferentially extending supporting ribs can also be provided.

The cross bracing 52 is also not needed. Another axial supporting device can also be provided instead. The storage section 50 can also extend in axial direction up to the connection end plate 34 where it can be supported. Advantageously, larger inlet apertures and/or a larger number of inlet apertures 58 can then be provided in the storage section 50 in the area of the connection end plate 34. The storage section 50 can also only partially be filled with additive.

The storage section 50 can also be firmly connected, for example by gluing or welding, with the bottom end plate 32.

The storage section 50 can also be open completely or only sectionwise towards the bottom end plate 32.

The corresponding axes of the filter element 26 and/or the filter medium 28 and/or the additive container 48; 148 and/or the screw-in axis and/or the axis 24 of the spin-on filter 10 must not all coincide.

It is also possible to provide only one inlet port 20.

Instead of only one cover outlet 22, several outlet ports for the engine oil can also be provided.

The filter element 26 can also be designed in such a way that the filter medium 28 can be flowed through in reverse direction, which means from radially inside to outside, rather from radially outside to inside. In this case, the positions of the inlet ports 20 and of the cover outlet 22 can be changed accordingly.

Instead of the screwed connection, the spin-on filter 10 can also be detachably connected by means of another connection, for example by means of a bayonet connection, with the filter head.

Instead of synthetic material, the bottom end plate 32 and/or the connection end plate 34 and/or the support tube 44 can also be made of a different material, for example metal.

Instead of the zigzag-folded filter medium 28, another filter medium, for example a wound filter medium, that surrounds the element interior space 30 in a closed manner, can be provided.

Instead of being cylindrically shaped, the filter medium 28 can also have a different shape, for example a conical shape.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A liquid filter (10) for oil, fuel or water comprising:
a filter housing (12) including
a first passage (20) for the inlet of liquid into the filter;
a second passage (22) for the outlet of the liquid from the filter;
a filter element (26) arranged within and secured within the filter housing, the filter element separating the first passage (20) from the second passage (22) such that fluid entering the first passage flows thorough the filter element to reach the second passage the filter element;
wherein the filter element has a filter element axis about which the filter element is arranged, the filter element axis aligned with and extending through the second passage (22);
wherein the filter element (26) circumferentially surrounds and defines an element interior space (30) positioned radially interior to the filter element (26), the element interior space (30) arranged on the filter element axis (24);
wherein the filter element (26) is flowed through for filtering liquid relative to the filter element axis (24) radially outside, from an element exterior space (42) towards radially inside to the element interior space (30), or reversely;
wherein the filter element includes
a filter medium (28) which circumferentially closes around the element interior space (30) of the filter element (26);
an additive container (48; 148) arranged within the interior space (30) of the filter element (26), the additive container including an additive and releasing the additive into the filtered liquid, the additive container including
at least one flow through opening (56, 58) conducting liquid flow and extending from at least one area (64) of the element interior space (30) outside of the additive container (48; 148) into an interior space (68) of additive container (48; 148);
wherein relative to the filter element axis (44), on a radially outer circumferential side of the additive container (48; 148) at least one spacer (60; 160) is secured which, on the one hand, is supported at the radially outer circumferential side of the additive container (48; 148) and, on the other hand, is supported indirectly or directly with its side facing away from the radially outer circumferential side of the additive container (48; 148) at the radially inner circumferential side of the filter medium (28) facing the element exterior space (30) relative to the filter element axis (24).

2. The exchangeable spin-on liquid filter according to claim 1, wherein
the at least one spacer includes at least one supporting rib (60) that extends relative to the filter element axis (24) at least circumferentially along at least one part of the radially outer circumferential side of the additive container (48).

3. The exchangeable spin-on liquid filter according to claim 2, wherein
the at least one supporting rib (60) extends along an imaginary helical line on the radially outer circumferential side of the additive container (48).

4. The exchangeable spin-on liquid filter according to claim 1, wherein
the at least one spacer includes at least one supporting rib (160) that extends in parallel or diagonally with respect to the filter element axis (24).

5. The exchangeable spin-on liquid filter according to claim 2, wherein
the at least one supporting rib (60; 160) includes at least one discontinuity (62) or break in the course of the supporting rib.

6. The exchangeable spin-on liquid filter according to claim 1, wherein
the radially outer circumferential side of the additive container (48; 148) is cylindrical or conical, and is coaxial with respect to the filter element axis (24).

7. The exchangeable spin-on liquid filter according to claim 1, wherein
the filter medium (28) is zigzag-folded circumferentially; and
wherein the at least one spacer (60) extends circumferentially over at least two, preferably three, fold edges that form the radially inner circumferential side of the filter medium (28).

8. The exchangeable spin-on liquid filter according to claim 1, wherein
the at least one spacer (60; 160) is supported at a radially inner circumferential side of a support tube (44) of the filter element (26) which is disposed in the element interior space (30) and on the radially outer circumferential side of which the radially inner circumferential side of the filter medium (28) is supported indirectly or directly.

9. The exchangeable spin-on liquid filter according to claim 1, wherein
the additive container (48; 148) is securely glued or welded at one front face onto an end plate (32, 34) of the filter element (56) which in turn is securely glued or welded onto a front face of the filter medium (28).

10. A filter element for filtration of oil, fuel or water that can be disposed in a filter housing (12) that features at least a first passage (20) for the inlet of liquid and at least a second passage (22) for the outlet of the liquid, in such a way that it separates the at least first passage (20) from the at least second passage (22), the filter element comprising:
a filter element axis about which the filter element is arranged, the filter element axis aligned with and extending through the second passage (22);
wherein the filter element (26) surrounds and defines an element interior space (30) positioned radially interior to the filter element (26), the element interior space (30) arranged on the filter element axis (24);
wherein the filter element (26) is flowed through for filtering liquid relative to the filter element axis (24) radially outside, from the element exterior space (42) towards radially inside to the element interior space (30), or reversely;
wherein the filter element includes
a filter medium (28) which circumferentially closes around the circumference of the element interior space (30) of the filter element (26);
an additive container (48; 148) arranged within the interior space (30) of the filter element (26), the additive container including an additive and releasing the additive into the filtered liquid, the additive container including
at least one flow through opening (56, 58) conducting liquid flow and extending from at least one area (64) of the element interior space (30) outside of the additive container (48; 148) into an interior space (68) of additive container (48; 148);
wherein relative to the filter element axis (44), on a radially outer circumferential side of the additive container (48; 148) at least one spacer (60; 160) is secured which, on the one hand, is supported at the radially outer circumferential side of the additive container (48; 148) and, on the other hand, is supported indirectly or directly with its side facing away from the radially outer circumferential side of the additive container (48; 148) at the radially inner circumferential side of the filter medium (28) facing the element exterior space (30) relative to the filter element axis (24).
